(19) United States
(12) Patent Application Publication
(10) Pub. No.: US 2009/0280901 A1
(43) Pub. Date: Nov. 12, 2009

(54) GAME CONTROLLER DEVICE AND METHODS THEREOF

(75) Inventors: Mark A. Casparian, Miami, FL (US); Jeffrey A. Cubillos, Miami, FL (US); Ignacio A. Quintana, Miami, FL (US)

Correspondence Address: LARSON NEWMAN & ABEL, LLP, 5914 WEST COURTYARD DRIVE, SUITE 200, AUSTIN, TX, 78730, US

(73) Assignee: DELL PRODUCTS, LP, Round Rock, TX (US)

(21) Appl. No.: 12/118,302

(22) Filed: May 9, 2008

(51) Int. Cl. A63F 13/06

(52) U.S. Cl. 463/37; 463/36

(57) ABSTRACT

A game controller includes a housing having a gun shape. The game controller includes a position sensor to determine a position of the controller. A game environment displayed at an eyewear display device is responsive to the controller position, so that a user can manipulate an in-game character via manipulations of the controller. The position sensor can determine a stance of the controller's user, and provide information to a game program to change an in-game character stance based on a change in the user's stance.

### FIELD OF THE DISCLOSURE

The present disclosure relates to information handling systems, and more particularly to game controller devices for information handling systems.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements can vary between different applications, information handling systems can also vary regarding what information is handled, how the information is handled, how much information is processed, stored, or communicated, and how quickly and efficiently the information can be processed, stored, or communicated. The variations in information handling systems allow for information handling systems to be general or configured for a specific user or specific use such as financial transaction processing, airline reservations, enterprise data storage, or global communications. In addition, information handling systems can include a variety of hardware and software components that can be configured to process, store, and communicate information and can include one or more computer systems, data storage systems, and networking systems.

One popular application for information handling systems, including computers and game consoles, is the computer game application. Typically, the game application displays a game environment to a user of the information handling system. The user interacts with the game via a game controller. Conventionally, the game controller is a plastic housing made to fit into a user's hand, with a surface including multiple buttons and a directional input, such as a joystick. While such game controllers allow a user to interact with the game application in different ways, they limit the immersiveness of the game experience for the user. Accordingly, an improved game controller device and methods thereof would be useful.

### BRIEF DESCRIPTION OF THE DRAWINGS

The present disclosure may be better understood, and its numerous features and advantages made apparent to those skilled in the art by referencing the accompanying drawings.

FIG. 1 is a block diagram of a game system according to one embodiment of the present disclosure.

FIG. 2 is a diagram of a particular embodiment of a game controller device of FIG. 1.

FIG. 3 is a block diagram of a game system according to another embodiment of the present disclosure.

FIG. 4 is a flow diagram of a method of changing a game environment based on input from a game controller device according to one embodiment of the present disclosure.

The use of the same reference symbols in different drawings indicates similar or identical items.

### DETAILED DESCRIPTION

The following description in combination with the Figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be utilized in this application. The teachings can also be utilized in other applications and with several different types of architectures such as distributed computing architectures, client/server architectures, or middleware server architectures and associated components.

For purposes of this disclosure, an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system can be a personal computer, a PDA, or any other suitable device and can vary in size, shape, performance, functionality, and price. The information handling system can include memory, one or more processing resources such as a central processing unit (CPU) or hardware or software control logic. Additional components of the information handling system can include one or more storage devices, one or more communications ports for communicating with external devices as well as various input and output (I/O) devices, such as a keyboard, a mouse, and a video display. The information handling system can also include one or more buses operable to transmit communications between the various hardware components.

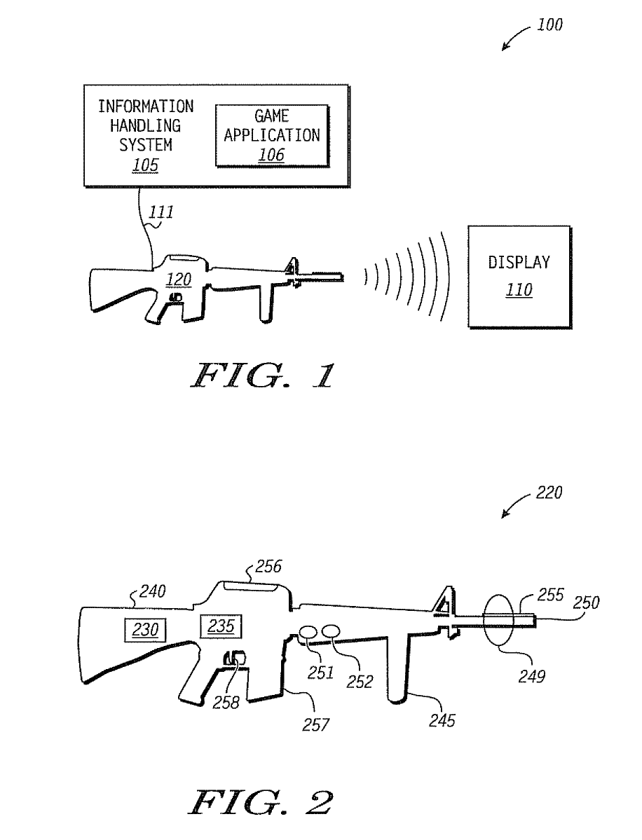

FIG. 1 illustrates a block diagram of an exemplary embodiment of a game system, generally designated at 100. The game system 100 includes an information handling system 105, a display 110, and a game controller 120. In one form, the information handling system 105 can be a computer system such as a personal computer. In another embodiment, the information handling system 105 is a game console. The information handling system 105 can include one or more processors (not shown) to execute applications, and a memory (not shown) to store applications and data resulting from the applications execution. In an embodiment, the information handling system 105 can support multiple processors and can allow for simultaneous processing of multiple processors and support the exchange of information within the system.

One application that is executable by the information handling system 105 is a game application 106. The game application 106 is an application configured to provide a game experience for a user. In particular, the game application 106 is configured to interact with a user based upon specified rules in order to provide the game experience. The game application 106 can be a first-person shooter game, a role play game, a real-time or turn based strategy game, a puzzle game, and the like.

In an embodiment, the game application 106 creates a game experience for a user by associating an in-game character with the user. Thus, a user's interactions with the game application result in actions performed by the game character associated with that user. The game application 106 can also create a game environment for the in-game character. As used herein, the term “game environment” refers to a virtual environment created by a game application with which a user can interact directly or via a game character. The game environment can also include the game character itself. Thus, changes to a game environment can include changes to a game character associated with a user, or changes to aspects of the environment with which the game character interacts. By changing the game environment based on a user's interactions with the environment, the game application 106 can create an immersive experience for the user.

The display 110 is configured to display one or more aspects of the game environment for a user. In an embodiment, the display 110 is configured to display portions of the game environment that are visible to an in-game character associated with a user. In another embodiment, the display 110 is configured to display aspects of the game environment selected by a user, such as particular game views, map displays, and the like.

The game controller 120 is configured to allow a user to interact with the game application 106, and the game environment created by the application, via manipulation of the controller. In particular that game controller 120 can communicate with the game application via a communication link 111. It will be appreciated that although for purposes of illustration the communication link 111 is shown as a physical link, in other embodiments the communication link 111 provides for wireless communication.

In the illustrated embodiment of FIG. 1, the game controller 120 is configured to provide the display 110. In particular, and as described further below, the game controller 120 can include a projector device, such as a pico-projector assembly, to project the display 110 onto a surface, such as a wall. This provides for enhanced user immersiveness with the displayed game environment.

To illustrate, the game controller 120 can include one or more sensors, described further below, that indicate a change in position of the controller. Information indicating this change in position is provided to the information handling system 105 via the communication link 111. The game application 106 changes the game environment based on the position change, and indicates changes to the displayed game environment via the communication link 111. In response, the display 110 projected by the game controller 120 is updated to reflect the change in the game environment.

The update to the game environment can be better understood with reference to an example. In the illustrated embodiment of FIG. 1, the game controller 120 is shaped as a gun, and the game application 106 is a shooter application that associates a user with an in-game character that wields a virtual gun corresponding to the game controller 120. The user can hold the gun and point it at a wall or other surface for projection of the display 110. The game application 106 determines which way the controller 120 is facing, and displays the game environment viewed by the in-game character via the display 110.

The user of the game controller 120 can turn the gun, so that the display 110 is projected onto another surface. The game controller 120 detects this turn, and communicates information indicating the turn to the game application 106. In response, the game application 106 determines that the turn of the controller results in a corresponding in-game turn of the in-game character associated with the user. Thus, the user's turning of the gun results in a matching turn of the in-game character. Further, the game application 106 updates the game environment visible by the in-game character in response to the turn, and provides information about the updated game environment to the game controller 120, which in turn projects the updated game environment at the display 110. Therefore, the user's turn of the controller 120 results in the display 110 being displayed on a new surface, and also results in an update to the displayed game environment, so that the display 110 reflects those portions of the game environment visible to the in-game character after the turn. In effect, the display 110 is changed so that the turning of the user is matched by a corresponding turning of the in-game character.

The game controller 120 can determine other movements or gestures and communicate those movements or gestures to the game application 106 for appropriate action. In one embodiment, the game controller 120 can determine a height of the controller from a surface, such as the floor. If a user movement results in a change of height of the game controller 120, the controller can communicate the change to the game application 106. In response, the game application 106 can determine that the change in height has resulted in a change of stance of the user of the game controller 120, and change the stance of the in-game character associated with the user accordingly. Further, the game application can update the display 110 projected by the game controller 120 based on the stance change, so that the view of the in-game character is changed to reflect the new stance.

For example, a user of the game controller 120 can move from a standing position to a kneeling position, resulting in the controller changing height from the floor. The game controller 120 can communicate the change in height to the game application 106, which determines the change of height indicates a change in stance of the user. In response, the game application 106 updates the status of an in-game character associated with the user to indicate the character has moved to a kneeling position, and updates the game environment accordingly. Further, the game application 106 updates the display information provided to the game controller 120 so that the display 110 reflects the change in stance of the in-game character. It will thus appear to the user that the display 110 has changed in response to his change of stance, thereby enhancing the immersiveness of the game experience.

In an embodiment, the game application 106 determines the stance of the user according to a set of pre-defined stances and position information associated with each stance. For example, the game application 106 can include a prone stance, a kneeling stance, a crouching stance, and a standing stance, and can associate position information for the game controller 120 for each stance. In response to the game controller 120 being placed in a position corresponding to a particular stance, the game application 106 updates the display 110 to reflect that an in-game character has adopted the corresponding stance. The position information for each stance can be set by a calibration mode of the game application 106, allowing a user to tailor the position information according to his physical dimensions and playing style.

The game controller 120 can be better understood with reference to FIG. 2, which illustrates a diagram of a particular embodiment of a game controller 220, corresponding to the game controller 120 of FIG. 1. In the illustrated embodiment of FIG. 2, the game controller 220 includes a housing 240 shaped like a gun. In the illustrated example, the housing 240 is shaped like a rifle, but in other embodiments that housing 240 can be shaped like a pistol, a grenade launcher, or other gun-shaped weapon. The gun-shaped housing 240 improves the immersiveness of the game experience by allowing a user to feel as if she is holding a weapon similar to a weapon wielded by an in-game character.

The game controller 220 also includes a position sensor 230 that is configured to provide position information for the controller. The position sensor 230 can be one or more accelerometers, gyroscopes, electronic compasses, e-field sensors, light sensors, and the like, or any combination thereof, that indicate a position of the game controller 220. In an embodiment, the position sensor 230 can indicate a change in position of the game controller 220 in one or more of three dimensions, such as an x-, y-, or z-axis. As explained above, a game application can, in response to an indication of a change in position, update a game environment to reflect a corresponding change in position of an in game character.

In another of embodiment, the positional sensors may reside external to the gun. They may be used in combination with the embedded positional sensor in the controller, or the external sensor may be used in place of any embedded sensor in the controller. For example, a camera configured to record three-dimensional information can provide information to the game controller 220 or directly to the information handling system 105 to indicate x, y and z axis positional movement of the game controller 220.

In other embodiments, the position sensor 230 can indicate a change in position that reflects a gesture by a user of the game controller 220, and the game application 106 can take appropriate action based on the gesture. For example, in one embodiment a user can indicate a “Stabbing” or “Punching” gesture by pushing the game controller 220 forward and backward with quick thrusts along the z-axis, towards the display 110. The game controller 220 can process the z axis signal over time to recognize the stabbing gesture, and in response send information to the game application 106 indicating a stabbing or punching command is sent to the game application 106. In response, the game application 106 can indicate that an in-game character associated with the user can effectuate a stabbing motion, initiate a melee attack, and the like. The game application 106 can determine whether the in-game weapon that effectuates the stabbing or punching motion is a fist, a bayonet, or other weapon by determining which weapon has been selected at the time when the gesture is recognized.

In an alternative method of embodiment, an external sensor may be used independently or in combination with the embedded position and angular sensors. For example, a camera configured to store three-dimensional information can be used to monitor the quick forward and back thrusting movement of the gun, in 180 degrees of space, and programmed to recognize this gesture, reporting it back to the game application, the game responding to this gesture and updating the display accordingly. Two cameras may be used to monitor for this gesture in 360 degrees of space.

In another embodiment, positional sensor 230 and angular sensor 235 may be used either separately or in combination with one another, to sense a “Reload” gesture. Such a gesture, for example, can be a quick tilt down and back up of the game controller 220. Upon processing the separate or combination of positional and angular sensors 230 and 235 over time to recognize the Reload gesture, the game controller 220 sends information indicating a reload command to the game application 106 and in response, the game application 106 effectuate an in-game reloading of ammunition and update the game environment accordingly.

In another embodiment, the reload gesture can be determined one or more sensors external to the game controller 220. For example, a camera configured to determine three-dimensional visual information can be employed to recognize quick the reload gesture in 180 degrees of space. Two cameras may be used in a room to detect this gesture in a 360 degree space. The external sensors can send information to the controller 220 or directly to the information handling system 105 indicating the gesture.

It will be appreciated that although for purposes of illustration the position sensor 230 is shown as single sensor, it can reflect multiple position and motion sensors distributed at the game controller 220. Further, as used herein, an indication that a sensor or other item is located at the housing 240 indicates that the item can be disposed on the housing, within the housing, coupled to the housing, physically integrated with the housing, and the like.

The game controller 220 also includes an angular sensor 235 located at the housing 240. The angular sensor 235 is configured to indicate a change in angular position of the housing 240, such as a tilt of the housing to one side. The game application 106 can change the game environment or position of an in-game character based on an indicated change of angular position. For example, in response to the angular sensor 235 indicating a change in angular position, the game application 106 can change the display 110 to reflect an in-game character leaning in a direction indicated by the change in angular position.

The game controller 220 further includes a trigger 258 and button 251 and 252. In an embodiment, the game controller 220 is configured to provide information to the game application 106 in response to depression or activation of one or more of the trigger 258 and buttons 251 and 252. Depending on which of the buttons 251 and 252 and trigger 258, the game application 106 can take appropriate action to update the game environment. For example, depression of the trigger 258 can result in firing of an in-game weapon, depression of the button 251 can result in a change to the rate of fire of the in-game weapon, and depression of the button 252 can result in a change of weapon for an in-game character. It will be appreciated that although buttons 251 and 252 have been described as buttons, in other embodiments either or both can be a scroll wheel, touchpad, directional pad, or other interactive control device.

The game controller 220 also includes a battery back 257. In an embodiment, the battery pack 257 includes one or more batteries to provide power for the game controller 220. In an embodiment, the battery back 257 is configured to be hot-swappable, so that it can be temporarily removed and replaced without loss of operation of the game controller 220. In the illustrated embodiment, the battery pack 257 is configured to appear as an ammunition clip, so that a user can replace the battery pack via insertion of the a new clip, further enhancing the immersiveness of the game experience. The game controller 220 can also be powered via an AC/DC adapter or other power source.

The game controller 220 further includes a power meter 256, which is configured to indicate the amount of power remaining at the battery pack 257. In one embodiment, the power meter 256 is configured to display the amount of power as an amount of ammunition remaining. In another embodiment, the power meter 256 is configured to display the amount of power remaining in response to activation of a button or other interactive device (not shown). The power meter 256 can be a set of LED or other lights, an LCD or other display, and the like.

In addition, the game controller 220 includes an input device 245 located at the housing 240. The input device 245 can be a joystick, a directional pad device, and the like. In response to a user interacting with the input device 245, the game controller can send information reflecting the interaction to the game application 106. In response, the game application 106 can change the status of an in-game character, update the game environment, and take other appropriate action. For example, in one embodiment a user can manipulate the input device 245 to change a position of an in-game character associated with the user. In the illustrated example, the input device 245 is integrated with the gun-shaped housing 240, allowing a user to manipulate the input device 245 while holding the housing 240 with a normal gun-like grip, thereby enhancing the immersiveness of the game experience for the user.

The game controller 220 also includes a projector 249 configured to project display of a game environment based on information provided by the game program 106. In the illustrated embodiment, the projector includes light engines 250 and 255, each configured to project display information provided by the game program 106. In an embodiment, the projector 249 is detachable, allowing a user to affix different projectors depending on the type of game and the user's surroundings. In the illustrated embodiment, the projector 249 is configured to appear as the barrel of the gun-shaped housing 240, thereby improving the immersiveness of the game experience.

In another embodiment, the projector 249, may be attached to the game controller 220 to have an integrated visual appearance with the controller. For example in one embodiment the projector 249 can be configured to appear similar to a rifle scope. Further, the projector 249 can include it has its own controller, battery pack, and communication interface (e.g. a USB 2.0 interface). The projector 249 can attach to the game controller 220 with an electrical connection made at the point of mechanical attachment whereby the projector can receive video input from the controller. When the projector 249 is detached from the game controller 220, it may operate independently as a projector for other information handling devices such as a personal computer, cellphones, multimedia devices such as personal music players, and the like.

FIG. 3 illustrates a block diagram of a particular embodiment of a game system 300, including an information handling system 305 and a game controller 320. The information handling system 305 and the game controller 320 are configured similarly to the information handling system 105 and game controller 120 of FIG. 1. However, in the illustrated embodiment of FIG. 3 the game controller 320 does not include a projector to project display of the game environment. In the illustrated example of FIG. 3, the game environment is displayed at an eyewear display device 360. As used herein, an eyewear display device is a device configured to be worn by a user as eyewear (e.g. eyeglasses) and to display a computer generated image at an eyepiece of the device, so that a user can view the image. Such devices are also known as personal viewers or head mounted displays (HMD). In some embodiments, the eyewear display device 360 can employ microdisplays, providing for enhanced image sharpness and luminous intensity compared to a projection display. Further, in some embodiments the eyewear display device 360 can provide for a larger field of view (FOV) that some projection displays, reducing viewer distraction. Thus, by displaying a game environment at the eyewear display device 360, a user's game experience can be enhanced.

In the illustrated example of FIG. 3, the eyewear display device 360 is worn by a user 345. The eyewear display device 360 includes sensors, such as sensor 361. The sensor 361 can be a motion sensor, a positional sensor, and the like. The sensor 361, individually or in conjunction with other sensors (not shown) can monitor 3 axes of movement of the head of user 345. Further, the eyewear display device 360 can communicate information from the sensor 361 indicating a change in position of the head to the information handling system 305 via communication link 362. In response, the game application 306 can update the game environment. For example, in one embodiment, the game application 306 can update a game display to reflect movement of an in-game character's head corresponding to the movement of the head of the user 245.

Other manipulations of the game controller 320, from external sensor inputs, such as a providing input about shooting-stance (height of controller from floor), or gestures as described with respect to FIG. 2, can result in corresponding changes to the game environment displayed at the eyewear display device 360.

In the illustrated embodiment of FIG. 3, the game system 300 includes a number of remote sensors, including sensors 371, 372, and 373. The sensors 371-373 interact with the position sensor 330 to determine a change in position of the game controller 330. For example, in an embodiment the sensors 371-373 are E-field sensors that project an electromagnetic field, and detect a change of position of the position sensor 330 within the field. In other embodiments, the sensors 371-373 can be visual sensors, such as cameras, or other sensors. The sensors 371-373 provide information to the information handling system 305 indicating a change in position of the game controller 305, allowing the game application 306 to take appropriate action based on the position change.

In the illustrated embodiment of FIG. 3, the positional information provided by the eyewear display device 360 and the sensors 370, 371, and 372 allows for independent updating of the game environment based on each set of positional information. This allows the capability to decouple and track movements of the head of user 245 separately from movement of the game controller 320. This enhances the user's immersive experience. For example, the game application 106 can provide audible sounds via a set of speakers (not shown) that simulates a sound occurring behind user 345. In response, the user 345 can quickly glance to the side. This change in position is detected by the sensor 361 and communicated to the game application 306. In response, the game application 306 updates the visual display at the eyewear display device 360 to reflect an in-game character looking to the side, corresponding to the head movement of the user 245. Meanwhile, the user 345 can manipulate the game controller 320 so that it is pointing forward, and the game environment is updated accordingly. Thus, if the user 345 activates a trigger or button of the game controller 320, the game application 306 can reflect this input by causing an in-game weapon associated with the user's in game character to fire. In this embodiment, the in-game weapon will fire in a direction corresponding to the position of the game controller 320, even if the sensor 361 indicates the head of the user 345 is facing in another direction. Thus, the user 345 can interact with the game application 306 such that the head of an in-game character is moved to one position (e.g. facing left) based on information provided by the sensor 345 while a weapon of the in-game character is moved to or remains in another position (e.g. facing forward or right).

In some game titles this ability to decouple head and weapon view is referred to as mouselook or freelook and further adds to the sensation of immersion on behalf of the user 345. The illustrated embodiment of FIG. 3 allows user 345 to leverage freelook in a more natural manner as opposed to current control systems for this feature. In addition, other physical motions and/or positions can be interpreted to allow user 345 to convey and experience the effect of “leaning” around corners in the game environment.

In an embodiment, the user 345 can select a particular game view to be displayed, whereby the selected game view can reflect the position of the eyewear display device 360 or the game controller 320. An input device, such as a button or switch, can be provided at the game controller 320 to select a particular view. For example, the user 345 can select a “character view” so that the game application 306 causes information to be displayed reflecting a point of view of an in-game character. The user can also select a “weapons view” whereby the game application 306 causes information to be displayed reflecting a position of an in-game weapon. The sensor 361 and sensors 371, 372, and 373 provide for independent changing of the information displayed by each view, depending on the respective positions of the eyewear display device 360 and the game controller 320, respectively.

In addition, employment of the sensors 371, 372, and 373 can provide for recognition of user gestures to further enhance the interactivity of the game application 306. For example, in one embodiment the sensors 371, 372, and 373 can monitor movement of the game controller 320 and determine whether a particular movement reflects a “Grenade throw” gesture (e.g. a gesture resembling a somewhat circular throwing motion). In addition, the sensors 371, 372 and 373 can provide positional information indicating not only the gesture itself, but also a direction or trajectory associated with the gesture. In response, the game application 306 can cause an in-game character to throw a grenade in an in-game direction and trajectory corresponding to the motion of the game controller 320.

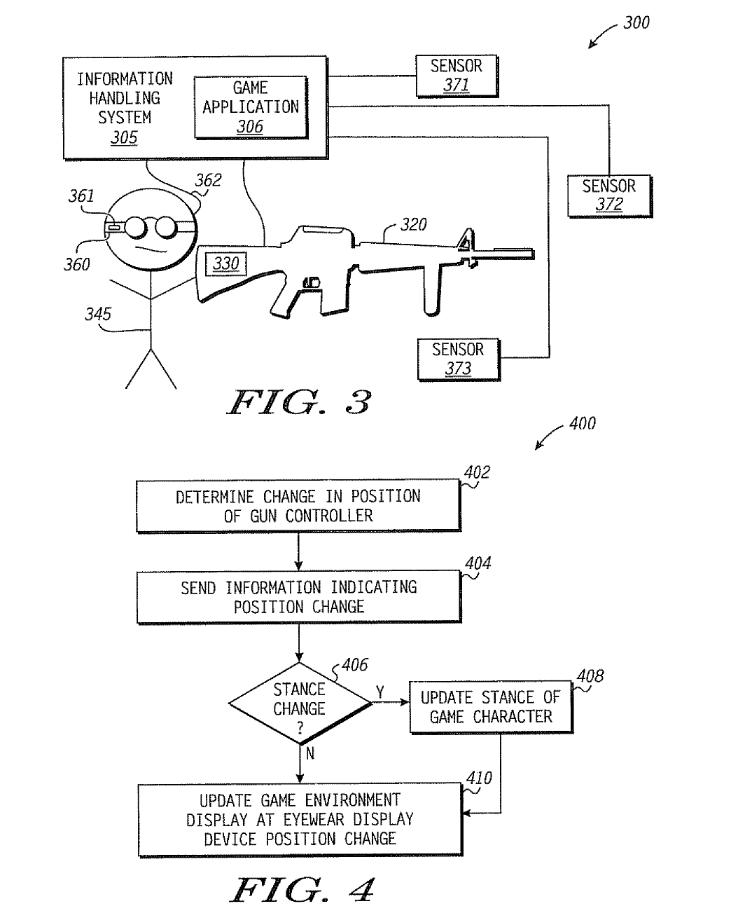

Referring to FIG. 4, a flow diagram of a particular embodiment of method of communicating information from a game controller is illustrated. At block 402, a position change is detected at a gun-shaped controller. The position change can be determined based on information provided by a position sensor located at the controller, based on information provided by sensors located remotely from the game controller, and the like. At block 404, information indicating the position change is communicated to an information handling system. At block 406, a game application at the information handling system determines whether the position change indicates a change in stance of a user of the game controller. For example, the game application can determine that a change in height of the game controller relative to a surface can indicate a change in user stance.

If the game application determines that a change in stance has not occurred, the method flow moves to block 410 and portions of a game environment displayed at an eyewear display device are updated based on the change in position of the game controller. If the game application determines the change in position of the controller does indicate a change in a user stance, the method flow moves to block 408 and the game application updates the stance of an in-game character associated with the user of the game controller. The method flow proceeds to block 410 and the game environment displayed at the eyewear display device is updated based on the change in stance of the in-game character and based on the change in position of the game controller.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A device, comprising:
a housing comprising a gun shape;
a projector coupled to the housing, the projector configured to project a display of a game environment; and
a first position sensor configured to determine a user stance based on a position of the housing.

2. The device of claim 1, wherein the projector is configured to change the display of the game environment in response to the first position sensor indicating a change in the user stance.

3. The device of claim 1, wherein the projector is configured to display the game environment based on information provided by the first position sensor to reflect a stance of a game character, the stance of the game character corresponding to the user stance.

4. The device of claim 1, wherein the user stance is selected from a plurality of specified user stances.

5. The device of claim 4, wherein the plurality of user stances includes a stance selected from the group consisting of a standing stance, a crouching stance, a kneeling stance, and a prone stance.

6. The device of claim 1, wherein the first position sensor is configured to determine the user stance based on a height of the housing relative to a surface.

7. The device of claim 1, further comprising:
a second position sensor configured to determine an angle of the housing.

8. A device, comprising
a housing comprising a gun shape;
a first position sensor configured to provide an indication of a position the housing; and
an interface coupled to the first position sensor, the interface configured to provide an indication of a first change in a game environment based on first information provided by the first position sensor, the game environment displayed at an eyewear display device.

9. The device of claim 8, wherein the first information provided indicates a stance of a game character.

10. The device of claim 9, wherein the first information indicates a height of the housing relative to a surface.

11. The device of claim 8, further comprising a directional input device located at the housing, wherein the interface is configured to provide an indication of a second change in the game environment based on second information provided by the directional input device.

12. The device of claim 8, further comprising a second position sensor, wherein the interface is configured to provide an indication of a game action based on second information provided by the second position sensor.

13. The device of claim 12, wherein the second information indicates a gesture with the housing.

14. The device of claim 8, further comprising a battery pack coupled to the housing, the battery pack configured to store a battery to provide power for the interface.

15. The device of claim 8, wherein the battery pack comprises an indicator configured to indicate an amount of power remaining in the stored batteries.

16. The device of claim 8, wherein the first position sensor is located at the housing.

17. The device of claim 8, wherein the first position sensor is located remote from the housing.

18. A method, comprising:
detecting a change in position of a game controller, the game controller comprising a gun-shaped housing; and
providing first information in response to detecting the change in position of the game controller, the first information configured to change display of a game environment at an eyewear display device.

19. The method of claim 16, wherein providing first information comprises providing first information indicating a change in stance of a user of the game controller.

20. The method of claim 16, wherein detecting a change in position of the game controller comprises detecting a specified game controller gesture.
